(19) United States
(12) Patent Application Publication
(10) Pub. No.: US 2026/0126056 A1
(43) Pub. Date: May 7, 2026

(54) IMPELLER, FAN, AND AIR HANDLER

(71) Applicant: GUANGDONG WELLING MOTOR MANUFACTURING CO., LTD., Foshan (CN)

(72) Inventors: Tingting JIANG, Foshan (CN); Cheng QIAN, Foshan (CN); Licheng ZHENG, Foshan (CN); Di WU, Foshan (CN); Jiaqi FANG, Foshan (CN); Qiqin SU, Foshan (CN)

(21) Appl. No.: 19/434,865

(22) Filed: Dec. 29, 2025

Related U.S. Application Data
(63) Continuation of application No. PCT/CN2024/101417, filed on Jun. 25, 2024.

(30) Foreign Application Priority Data
Aug. 1, 2023 (CN) 202310960103.1

(51) Int. Cl. F04D 29/54; F04D 19/00; F04D 29/32; F24F 7/007

(52) U.S. Cl. CPC F04D 29/542; F04D 19/002; F04D 29/325; F24F 7/007

(57) ABSTRACT

An impeller, a fan, and an air handler. The impeller includes a first end plate, a second end plate, and a plurality of blades. The second end plate and the first end plate are sequentially spaced apart along an air intake direction of the impeller, and the second end plate is provided with an air inlet. The plurality of blades are spaced apart along a circumference of the impeller, the blades are connecting the first end plate and the second end plate, the first end plate includes a first plate portion and a second plate portion surrounding a periphery of the first plate portion, and the second plate portion extends obliquely in the air intake direction away from an axis of the impeller.

This application is a continuation application of International (PCT) Patent Application No. PCT/CN2024/101417, filed on Jun. 25, 2024, which claims priority to Chinese Patent Application No. 202310960103.1, filed on Aug. 1, 2023, the entire contents of which are incorporated herein by reference.

### TECHNICAL FIELD

The present application relates to the technical field of fans, and in particular to an impeller, a fan, and an air handler.

### BACKGROUND

The impeller used in centrifugal fans typically includes two end plates opposite to each other and multiple blades located between the two end plates. The end plates are usually flat, which may result in significant flow losses and turning losses when the airflow enters the impeller, thus leading to low efficiency of the centrifugal fan.

### SUMMARY

An objective of the present application is to provide an impeller designed to improve its efficiency.

The present application provides an impeller, including:
a first end plate and a second end plate, the second end plate and the first end plate being sequentially spaced apart along an air intake direction of the impeller, the second end plate being provided with an air inlet; and
a plurality of blades spaced apart along a circumference of the impeller, the blades connecting the first end plate and the second end plate, the first end plate including a first plate portion and a second plate portion surrounding a periphery of the first plate portion, the second plate portion extending obliquely in the air intake direction away from an axis of the impeller.

In some embodiments, a surface of the first plate portion is orthogonal to the axis of the impeller.

In some embodiments, the second end plate includes a third plate portion and a fourth plate portion surrounding a periphery of the third plate portion, the fourth plate portion extending obliquely in the air intake direction away from the axis of the impeller.

In some embodiments, a first reference plane is defined to be perpendicular to the axis of the impeller, and an angle γ between the second plate portion and the first reference plane is configured to be 10°≤γ≤40°, and/or an angle δ between the fourth plate portion and the first reference plane is configured to be 10°≤δ≤40°.

In some embodiments, an outer diameter of the first end plate is smaller than an outer diameter of the second end plate.

In some embodiments, a ratio of the outer diameter of the first end plate to the outer diameter of the second end plate is greater than or equal to 0.7; and/or

in a radial direction of the air inlet, a dimension between a projection line of the blade on an axial section of the air inlet and an axis of the air inlet gradually decreases along the air intake direction.

In some embodiments, the blade has a first end and a second end that are sequentially distributed in the air intake direction, the second end extending outward in a radial direction of the impeller and beyond a periphery of the first end plate.

In some embodiments, a trailing edge of the second end extends beyond the first end plate in the air intake direction; or a trailing edge of the second end has an outwardly convex transition fillet connected to an edge of the first end plate.

In some embodiments, in the air intake direction, the trailing edge of the blade extends obliquely away from a rotation direction of the impeller.

In some embodiments, a second reference plane is defined passing through both the axis of the impeller and a center point of the trailing edge of the blade, and an angle between the trailing edge of the blade and the second reference plane is less than or equal to 45°.

In some embodiments, the blade has a first end and a second end sequentially distributed in the air intake direction, and a periphery of the second end plate extends radially outward from the impeller and beyond the first end; and/or
an outlet installation angle of the blade is less than 90°; and/or

The present application further provides a fan, including: a motor and the impeller as described above, a rotation shaft of the motor being provided on the first end plate of the impeller.

In some embodiments, the fan further includes: an air deflector disposed upstream of the impeller and having a cross-sectional area that gradually decreases in the air intake direction, the air deflector having a drainage end and a guide end sequentially distributed in the air intake direction, the guide end extending into the air inlet of the second end plate.

In some embodiments, in the radial direction of the impeller, a gap d between the guide end and an edge of the air inlet is configured to be 4 mm≤d≤10 mm; and/or
a depth H of the guide end extending into the air inlet is configured to be 5 mm≤H≤15 mm.

The present application further provides an air handler, including: the impeller as described above, or the fan as described above.

### BRIEF DESCRIPTION OF THE DRAWINGS

To more clearly illustrate the technical solutions in the embodiments of the present application or the related art, the accompanying drawings used in the description of the embodiments or the related art will be briefly introduced below.

FIG. 1 is a structural schematic view of an impeller according to some embodiments of the present application.

FIG. 2 is a side view of the impeller shown in FIG. 1.

FIG. 3 is a cross-sectional view of the impeller shown in FIG. 1, with a cutting plane passing through an axis of the impeller.

FIG. 4 is a cross-sectional view of the impeller according to some embodiments of the present application, with the cutting plane passing through the axis of the impeller.

FIG. 5 is a structural schematic view of the impeller according to some embodiments of the present application.

FIG. 6 is a side view of the impeller shown in FIG. 5.

FIG. 7 is a structural schematic view of a fan according to some embodiments of the present application.

FIG. 8 is a cross-sectional view of the fan shown in FIG. 7, with the cutting plane passing through the axis of the impeller.

FIG. 9 is a structural schematic view of an air handler according to some embodiments of the present application.

FIG. 10 is a schematic diagram of internal structure of the air handler shown in FIG.

FIG. 11 is a comparison chart of the required rotation speeds of the impeller of the present application and an impeller of equal diameter under the same efficiency and air volume.

FIG. 12 is a comparison chart of the efficiency of a fan using the impeller of the present application and a fan using a conventional impeller.

### DESCRIPTION OF REFERENCE SIGNS

| Reference sign | Name | Reference sign | Name |
|---|---|---|---|
| 10 | impeller | 131 | first end |
| 11 | first end plate | 132 | second end |
| 11a | installation hole | 133 | leading edge |
| 111 | first plate portion | 134 | trailing edge |
| 112 | second plate portion | 135 | transition fillet |
| 12 | second end plate | 21 | rotation shaft |
| 12a | air inlet | 22 | flange |
| 121 | third plate portion | 31 | air deflector |
| 122 | fourth plate portion | 41 | air duct |
| 13 | blade | 42 | heat exchanger |
| 13a | cross-sectional shape | 43 | installation plate |

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings.

It should be noted that if there is a directional indication (such as up, down, left, right, front, rear . . . ) in the embodiments of the present application, the directional indication is only used to explain the relative positional relationship, movement, etc. of the components in a certain posture (as shown in the drawings). If the specific posture changes, the directional indication will change accordingly.

In the present application, unless otherwise clearly specified and limited, the terms “connected”, “fixed”, etc. should be interpreted broadly. For example, “fixed” can be a fixed connection, a detachable connection, or a whole; can be a mechanical connection or an electrical connection; may be directly connected, or indirectly connected through an intermediate medium, and may be the internal communication between two elements or the interaction relationship between two elements, unless specifically defined otherwise. For those of ordinary skill in the art, the specific meaning of the above-mentioned terms in the present application can be understood according to specific circumstances.

It should be noted that, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. Besides, the meaning of “and/or” appearing in the present application includes three parallel scenarios. For example, “A and/or B” includes only A, or only B, or both A and B. In addition, the technical solutions between the various embodiments can be combined with each other.

The present application provides an impeller, a fan, and an air handler. The impeller is applied to the fan, and the fan is applied to the air handler. The fan can also be applied to a ventilation system or other air conditioning systems.

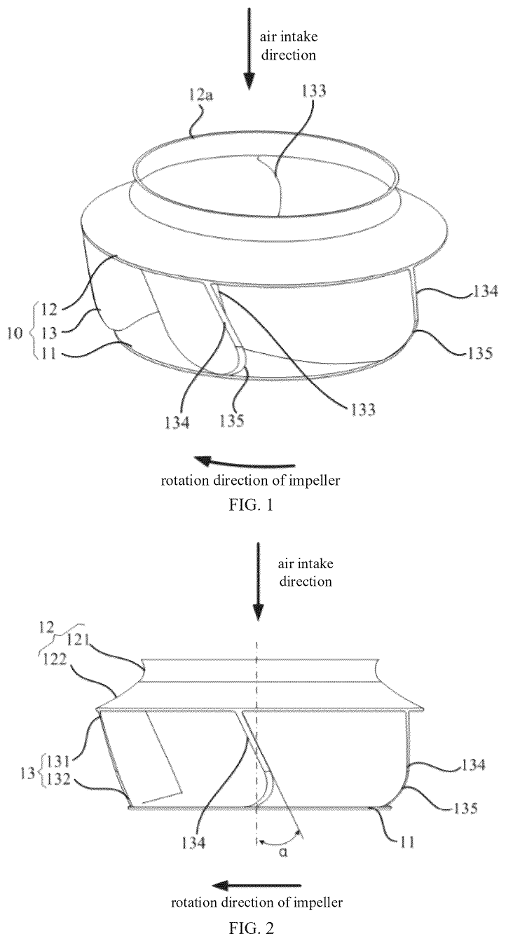

As shown in FIG. 1 to FIG. 6, in some embodiments of the present application, the impeller 10 includes a first end plate 11, a second end plate 12 and a blade group. The second end plate 12 and the first end plate 11 are sequentially spaced apart along an air intake direction of the impeller 10, and the second end plate 12 is provided with an air inlet 12a. The blade group includes a plurality of blades 13 spaced apart along a circumference of the impeller 10, the blades 13 are connecting the first end plate 11 and the second end plate 12, the first end plate 11 includes a first plate portion 111 and a second plate portion 112 surrounding a periphery of the first plate portion 111, and the second plate portion 112 is extending obliquely in the air intake direction away from an axis of the impeller 10.

In technical solutions of the present application, by improving the structure of the first end plate 11 facing the air inlet 12a, the second plate portion 112 extends outward in the air intake direction, the degree of turning of the airflow flowing in from the air inlet 12a within the impeller 10 can be reduced, thereby reducing the impact loss and turning loss of airflow energy, and thus improving the efficiency of the impeller 10.

It should be noted that the circumference of the impeller 10 refers to the circumferential direction around the axis of the impeller 10, while the radial direction of the impeller 10 refers to any direction radiating outwards from the axis of the impeller 10 on a plane perpendicular to the axis of the impeller 10.

In some embodiments of the present application, the outlet installation angle of the blades 13 is less than 90°, that is, the impeller 10 of the present application is configured as a centrifugal impeller 10 with backward-curved blades 13, so that the fan can have higher efficiency and a larger flow rate. In other embodiments, the outlet installation angle of the blades 13 may be greater than or equal to 90°, that is, they may also be configured as forward-curved blades 13 or radial blades 13.

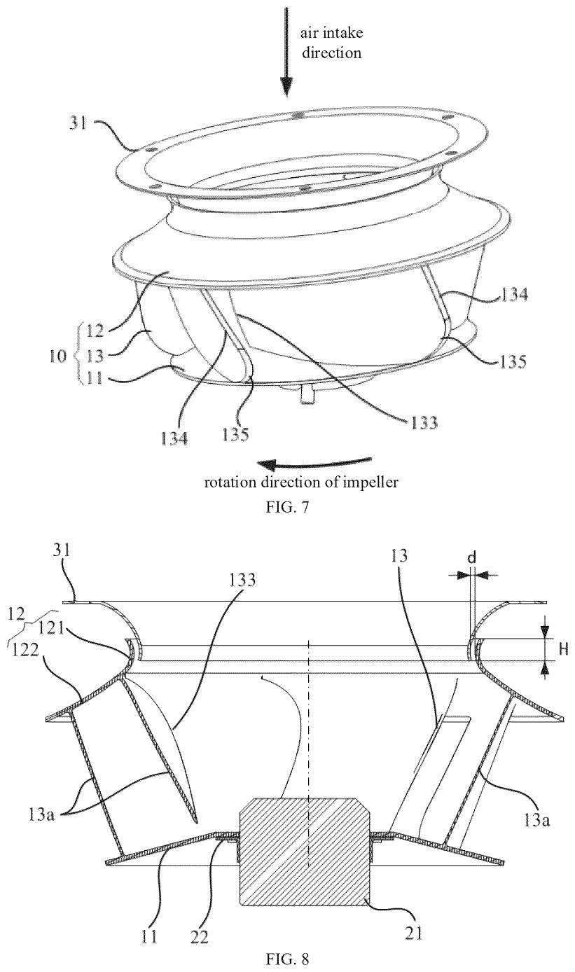

As shown in FIG. 7 and FIG. 8, in some embodiments of the fan of the present application, the fan includes a motor, an air deflector 31 and the impeller 10 as described above. A rotation shaft 21 of the motor is provided on the first end plate 11 of the impeller 10, to drive the first end plate 11 and the entire impeller 10 to rotate. The air deflector 31 is located upstream of the impeller 10. The cross-sectional area of the air deflector 31 gradually decreases in the air intake direction. The air deflector 31 has a drainage end and a guide end sequentially distributed in the air intake direction. The drainage end is installed in the air duct 41 and the guide end extends into the air inlet 12a of the second end plate 12, serving to introduce the air upstream of the impeller 10 in the air duct 41 into the air inlet 12a of the second end plate 12. In other embodiments, the fan may not have the air deflector 31.

In some embodiments, the first plate portion 111 has an installation hole 11a, and the end of the rotation shaft 21 of the motor extends into the installation hole 11a. A flange 22 is provided on the outer circumferential surface of the rotation shaft 21, and the flange 22 is fastened to the first plate portion 111 by screws. This improves the reliability and ease of installation of the rotation shaft 21 of the motor. In other embodiments, the first end plate 11 may not have the installation hole 11a; the rotation shaft 21 of the motor may be directly fixed to the outer surface of the first end plate 11, or the rotation shaft 21 of the motor may be fixed to the first end plate 11 by riveting, snap-fitting, or bonding.

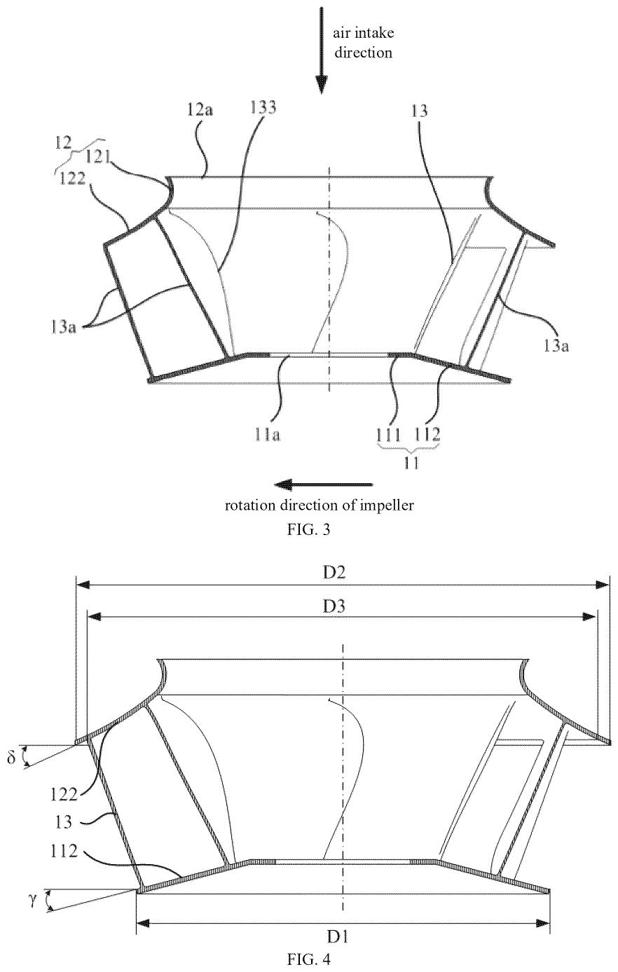

As shown in FIG. 3 and FIG. 4, in some embodiments, a surface of the first plate portion 111 is orthogonal to the axis of the impeller 10. Thus, the straight first plate portion 111 and the inclined second plate portion 112 work together to effectively guide the airflow flowing in from the air inlet 12a, thereby reducing turning losses without significantly reducing the pressure rise effect of the impeller. It should be noted that orthogonal refers to a vertical or near-vertical state. In other embodiments, the first plate portion 111 can also be inclined like the second plate portion 112.

As shown in FIG. 7 and FIG. 8, in some embodiments, in the radial direction of the impeller 10, a gap d between the guide end and an edge of the air inlet 12a is configured to be 4 mm≤d≤10 mm. It is understandable that if the gap d is too small, the second end plate 12 is prone to motion interference and collision with the air deflector 31 during the rotation of the second end plate 12 relative to the air deflector 31. If the gap d is too large, the air in the air duct 41 can easily enter the air inlet 12a of the impeller 10 through the gap, forming a significant circulating airflow that does no work. The gas in this circulating airflow enters the air inlet 12a through the gap, flows out of the impeller 10, turns back around the second end plate 12, and flows back to the gap, then re-enters the air inlet 12a through the gap. Therefore, by limiting the gap d to within 10 mm, the no-work circulating airflow is weakened, thereby improving the efficiency of the impeller 10.

In some embodiments, a depth H of the guide end extending into the air inlet 12a is configured to be 5 mm≤H≤15 mm. It is understandable that if the depth H is too small, the fit gap between the guide end and the air inlet 12a will be too short, resulting in insufficient obstruction of the circulating airflow; if the depth H is too large, the size and volume of the guide end will be too large, leading to high manufacturing costs.

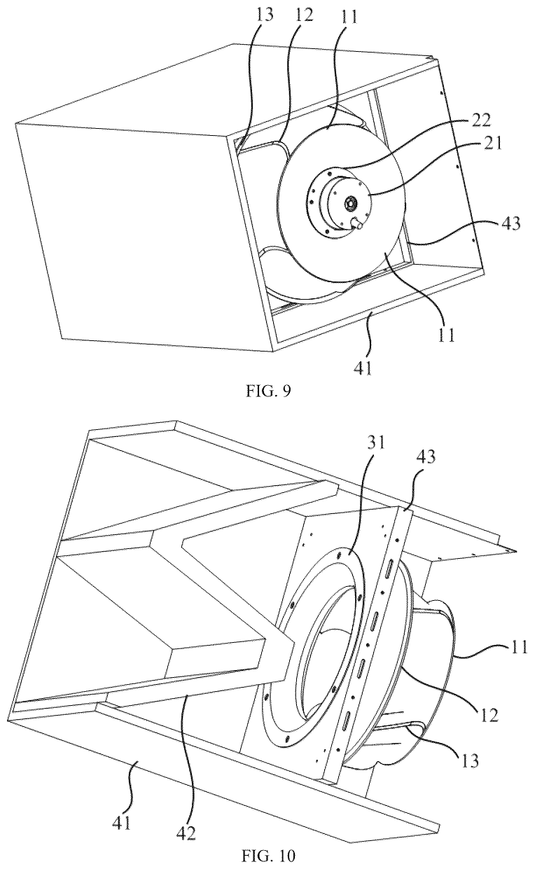

As shown in FIG. 9 and FIG. 10, in some embodiments of the air handler of the present application, the air handler includes an air duct 41, a heat exchanger 42, and the aforementioned fan. Both the heat exchanger 42 and the fan are installed within the air duct 41, and the heat exchanger 42 is located upstream of the fan. The heat exchanger 42 is used to heat or cool the air within the air duct 41. The air deflector 31 of the fan is fixed to the air duct 41 by an installation plate 43. The motor is fixed to the air duct 41 by an installation bracket, and the rotation shaft 21 of the motor extends towards the air deflector 31 and is equipped with an impeller 10. In other embodiments, the air handler may not have the heat exchanger 42, or the heat exchanger 42 may be located downstream of the fan.

Furthermore, to meet year-round air conditioning requirements, the air handler may also include at least one component such as a humidifier and a filter. In this way, clean air is sent by a fan to a cooler or heater for cooling or heating to the required temperature before being delivered to the desired location. Because the air handler primarily deals with the state of indoor recirculated air, and with the aforementioned fan, it can handle large air volumes and provide high air quality, making it particularly suitable for ventilation in large spaces with high traffic volumes, such as computer rooms, shopping malls, exhibition halls, and airports.

In technical solutions of the present application, within the constraints of system equipment size, by maximizing the load on impeller 10 and reducing the turning loss of airflow energy, the rotation speed of impeller 10 can be reduced as much as possible while meeting the same pressure rise requirements. This significantly improves the rotational noise of impeller 10 and increases efficiency, thereby achieving the design goals of quiet and high-efficiency fan operation. On the other hand, the volute-less structural design significantly reduces dynamic and static interference noise, further enhancing the overall quietness of the unit.

To further improve the efficiency of the impeller 10, as shown in FIG. 1 to FIG. 6, in some embodiments, the second end plate 12 includes a third plate portion 121 and a fourth plate portion 122 surrounding a periphery of the third plate portion 121, the fourth plate portion 122 is extending obliquely in the air intake direction away from the axis of the impeller 10. That is, the fourth plate portion 122 extends in the same direction as the second plate portion 112, also extending outwards at an angle in the air intake direction. The fourth plate portion 122 guides the airflow, working together with the second plate portion 112 to direct the airflow to the rear side of the impeller 10, thereby further reducing impact and turning losses of the airflow energy and improving the efficiency of the impeller 10. On the other hand, the angled extension of the fourth plate portion 122 also reduces the degree of vortex generation caused by airflow falling off the inner wall surface of the fourth plate portion 122, and improves the flow field inside the impeller 10, thereby reducing flow energy loss.

In some embodiments, a first reference plane is defined to be perpendicular to the axis of the impeller 10, and an angle γ between the second plate portion 112 and the first reference plane is configured to be 10°≤γ≤40°. That is, the tilt angle of the second plate portion 112 relative to the plane where the air inlet 12a is located is limited. It can be understood that if the tilt angle of the second plate portion 112 is too small, the effect of reducing the degree of airflow turning will be insufficient, resulting in an insignificant effect on reducing the impact loss and turning loss of airflow energy; if the tilt angle of the second plate portion 112 is too large, most of the airflow will flow out along the axis of the impeller 10 with almost no turning, resulting in a weakening of the pressure rise of the airflow when flowing through the impeller 10.

As shown in FIG. 2 and FIG. 4, in some embodiments, an angle δ between the fourth plate portion 122 and the first reference plane is configured to be 10°≤δ≤40°. That is, the tilt angle of the fourth plate portion 122 relative to the plane where the air inlet 12a is located is limited. It can be understood that if the tilt angle of the fourth plate portion 122 is too small, the effect of reducing the degree of airflow turning will be insufficient, resulting in an insignificant effect on reducing the impact loss and turning loss of airflow energy; if the tilt angle of the fourth plate portion 122 is too large, most of the airflow will flow out along the axis of the impeller 10 with almost no turning, resulting in a weaker pressure rise of the airflow when flowing through the impeller 10.

As shown in FIG. 2 and FIG. 4, in some embodiments, the angle δ between the fourth plate portion 122 and the first reference plane is greater than the angle γ between the second plate portion 112 and the first reference plane. That is, along the extension direction of the air outlet channel formed by the intervals between two adjacent blades 13, the distance between the second plate portion 112 and the fourth plate portion 122 gradually decreases in the direction away from the axis of the impeller 10. This allows the airflow to be guided more smoothly to the rear side of the impeller 10, thereby reducing airflow loss and improving the efficiency of the impeller 10. In other embodiments, the angle δ may be less than or equal to the angle γ.

As shown in FIG. 2 and FIG. 4, in order to further reduce the impact loss of airflow energy, in some embodiments, the outer diameter D1 of the first end plate 11 is smaller than the outer diameter D2 of the second end plate 12. Thus, the smaller size of the first end plate 11 can further reduce the impact loss and turning loss of airflow energy, and improve the efficiency of the impeller 10. In other embodiments, the outer diameter D1 of the first end plate 11 can be greater than or equal to the outer diameter D2 of the second end plate 12.

It should be noted that, in some embodiments, the outer contours of both the first end plate 11 and the second end plate 12 are configured as circular or approximately circular features. Therefore, the outer diameters of the first end plate 11 and the second end plate 12 refer to the diameter of the circle containing their outer contours. In embodiments where the outer contours of the first end plate 11 and the second end plate 12 are of other shapes, such as rectangular, polygonal, or irregular curves, their outer diameter refers to the diameter of the circumscribed circle tangent to the outer contour. That is, the orthographic projection of the second end plate 12 onto the first reference plane falls within the region of the orthographic projection of the first end plate 11 onto the first reference plane.

In some embodiments, a ratio of the outer diameter D1 of the first end plate 11 to the outer diameter D2 of the second end plate 12 is greater than or equal to 0.7, that is, D1/D2≥0.7. It can be understood that if the ratio of the outer diameter D1 of the first end plate 11 to the outer diameter D2 of the second end plate 12 is too small, it means that the size of the first end plate 11 is too small. In this case, most of the airflow will flow out along the axis of the impeller 10 without turning, resulting in a weaker pressure rise of the airflow when it flows through the impeller 10.

In some embodiments, a plurality of blades 13 are connected between the first end plate 11 and the second end plate 12 and are arranged around the axis of the air inlet 12a, forming an air outlet between the first end plate 11 and the second end plate 12. In the axial direction of the air inlet 12a, the diameters of the circumferences formed by the blades 13 are different. When the impeller is applied inside the fan, under the size limitation of the fan duct, the load on the impeller can be maximized, thereby meeting the pressure rise requirements while minimizing the rotation speed, thus improving noise and reducing airflow loss under the action of the impeller, and improving efficiency.

When the impeller is applied inside the fan, the airflow will change from radial flow to flow along the impeller axis through its cooperation with the air duct. Since the diameters of the circumferences formed by the blades 13 in the axial direction of the air inlet 12a are not equal, that is, based on the specific structure of the blades 13, the diameter of each circumference can gradually decrease along the direction from the second end plate 12 to the first end plate 11, or the diameter of each circumference can first increase and then decrease, or the diameter of each circumference can first decrease and then increase. In this case, the impeller formed by the connection of the first end plate 11 and the second end plate 12 is a non-equal diameter impeller. This setting can effectively reduce the rotation speed, improve noise, and effectively reduce losses when turning, thereby improving efficiency.

The outer diameter of the first end plate 11 is smaller than the outer diameter of the second end plate 12. Since the second end plate 12 guides the airflow to the blades 13, the first end plate 11 allows the airflow to flow at a certain angle towards the outlet and out of the outlet. This angle setting, while assisting the airflow, also facilitates changes in the flow direction when combined with the duct. Simultaneously, it limits the outer diameter of the second end plate 12 from being larger than that of the first end plate 11, allowing for the formation of a bladeless diffuser zone between the second end plate 12 and the duct wall. This reduces ineffective work done by the airflow passing through the impeller, further improving static pressure efficiency and reducing noise.

Therefore, in the axial direction of the air inlet 12a, by designing that the diameters of the circumferences formed by the blades 13 are not equal, and in conjunction with the setting that the outer diameter of the first end plate 11 is smaller than the outer diameter of the second end plate 12, when the impeller is applied inside the fan, the load on the impeller can be maximized under the size constraints of the fan duct. Thus, while meeting the pressure rise requirements, the rotation speed is reduced as much as possible, effectively improving noise and airflow loss under the action of the impeller, and improving efficiency.

As shown in FIG. 2 and FIG. 4, in a radial direction of the air inlet 12a, a dimension between a projection line of the blade 13 on an axial section of the air inlet 12a and an axis of the air inlet 12a gradually decreases along the air intake direction. That is, the cross-sectional shape 13a of the blade 13 on the axial section of the impeller 10 extends obliquely towards the axis of the impeller 10 in the air intake direction. Specifically, in the embodiments shown in FIG. 2 and FIG. 4, the axial section of the impeller 10 intercepts positions of the three blades 13. The cross-sectional shape 13a of these three blades 13 is generally rectangular, and the cross-sectional shape 13a of each blade 13 extends obliquely towards the axis of the impeller 10 in the air intake direction. Thus, on the one hand, under the same size conditions, the cross-sectional area of the air outlet channel can be increased, which is beneficial to converting the kinetic energy of the airflow into static pressure energy, thereby improving the pressure rise effect of the impeller 10. On the other hand, along the direction from the second end plate 12 to the first end plate 11, the projection line gradually approaches the axis of the air inlet 12a, or the diameter of the circumference formed by each blade 13 gradually decreases. At this time, the impeller formed by the connection of the first end plate 11 and the second end plate 12 is a non-equal diameter impeller, and the limitations such as D2 being less than D1 and 0.7≤D1/D2<1 are beneficial to further reliably reduce the speed, improve noise, reduce losses when turning, and improve efficiency.

In other embodiments, the cross-sectional shape 13a of the blade 13 on the axial section of the impeller 10 may extend along the axial direction of the impeller 10, or it may extend obliquely away from the axial direction of the impeller 10 in the air intake direction.

In some embodiments, the blade 13 has a first end 131 and a second end 132 sequentially distributed in the air intake direction, and the second end 132 extends radially outward from the impeller 10 and beyond the periphery of the first end plate 11. That is, the outer diameter D1 of the first end plate 11 is smaller than the maximum outer diameter D4 of the blade group at the end closest to the first end plate 11. Thus, by reducing the outer contour dimensions of the first end plate 11 to weaken airflow losses, the second end 132 of the blade 13, extending outward beyond the first end plate 11, can still guide the airflow, thereby increasing the effective length of the outlet passage to some extent and improving the efficiency of the impeller 10. In other embodiments, in the radial direction of the impeller 10, the second end 132 is flush with the periphery of the first end plate 11, or the periphery of the first end plate 11 extends beyond the second end 132.

In some embodiments, the blade 13 has a leading edge 133 near the air inlet 12a and a trailing edge 134 away from the air inlet 12a. The second end 132 can protrude outwards in various ways. For example, as shown in FIG. 1 and FIG. 3, in some embodiments, the trailing edge 134 of the second end 132 extends beyond the first end plate 11 in the air intake direction. Thus, the second end 132 extends beyond the boundary of the first end plate 11 not only radially beyond the impeller 10 but also in the air intake direction, thereby further improving the efficiency of the impeller 10.

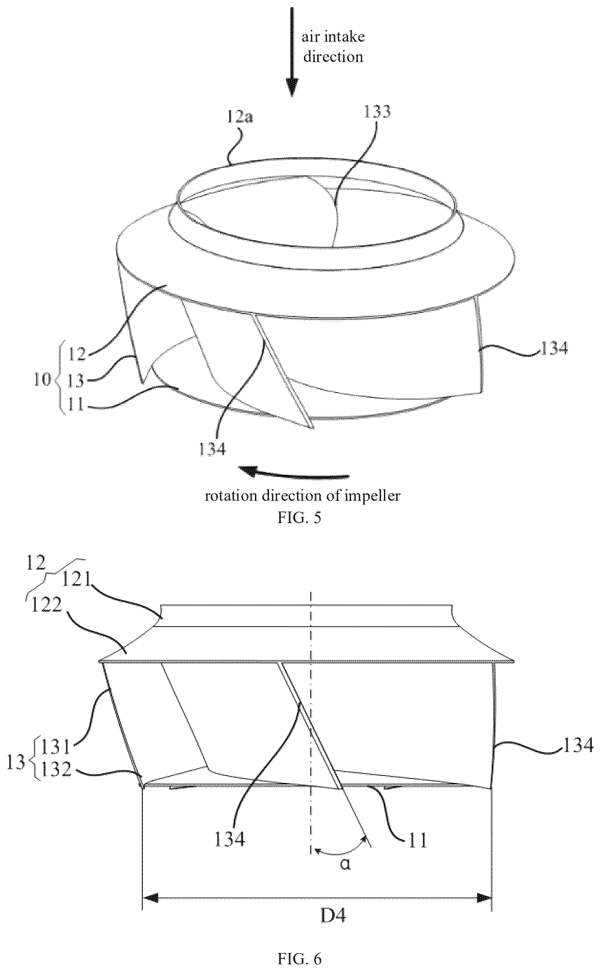

In some embodiments, the second end 132 can also be in other outward protrusion manner. For example, as shown in FIG. 5 and FIG. 6, in some embodiments, the trailing edge 134 of the second end 132 can be provided with an outwardly protruding transition fillet 135, which connects to the edge of the first end plate 11. In this way, not only can the efficiency of the impeller 10 be improved, but the feature of the transition fillet 135 can also be used to make the trailing edge 134 of the blade 13 smoothly connect with the first end plate 11, avoiding the problem of insufficient local structural strength of the trailing edge 134 of the blade 13.

In some embodiments, the blades 13 have a first end 131 and a second end 132 sequentially distributed in the air intake direction. The periphery of the second end plate 12 extends radially outward from the impeller 10 beyond the first end 131. That is, the outer diameter D2 of the second end plate 12 is larger than the maximum outer diameter D3 of the blade assembly at the end closest to the second end plate 12. This shortens the distance between the periphery of the second end plate 12 and the inner wall of the air duct 41, and forms a bladeless diffuser region between the second end plate 12 and the air duct 41, thereby improving the static pressure energy and static pressure efficiency of the impeller 10. On the other hand, by shortening the distance between the periphery of the second end plate 12 and the inner wall of the air duct 41, and through the guiding effect of the fourth plate portion 122, the gas flowing out of the impeller 10 can be prevented from bypassing the second end plate 12 and returning to the air inlet 12a, thereby reducing the circulating gas that does useless work and thus improving the efficiency of the impeller 10. In other embodiments, the outer diameter of the second end plate 12 may be equal to or smaller than the outer diameter of the blade group at the end closest to the second end plate 12.

Generally speaking, the performance of mixed-flow impellers is mainly reflected in air volume and noise control. Air volume and noise level are interdependent; generally, a larger air volume results in higher noise, and a smaller air volume results in lower noise. Furthermore, air volume is directly proportional to rotation speed.

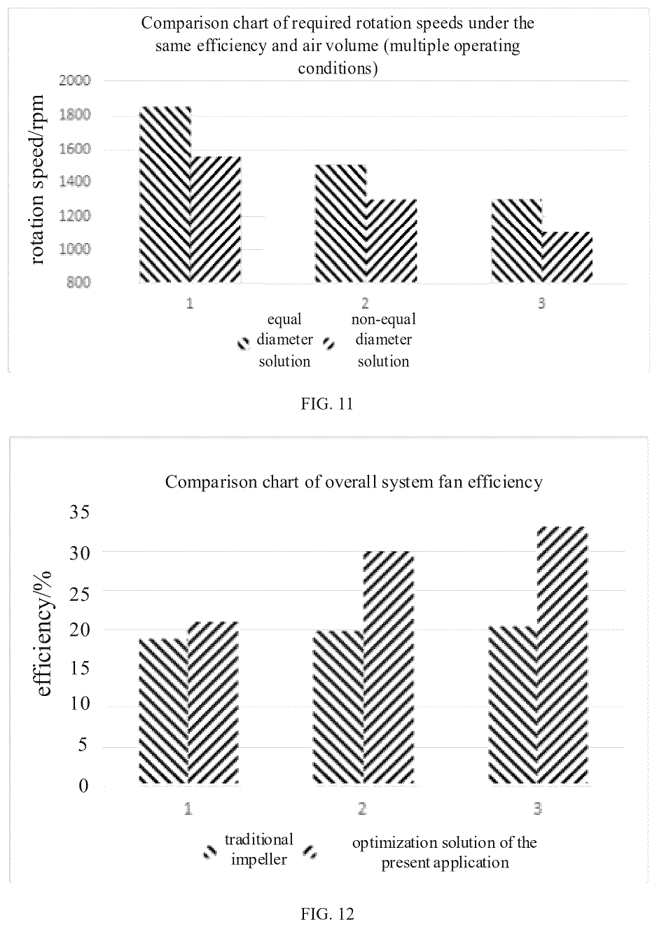

By combining parameters such as 0.7≤D1/D2<1, D1>D4, and D2>D3, and by setting the diameter of each circumference formed by the blades 13 along the axial direction of the air inlet to gradually decrease, the impeller is configured as a non-equal diameter impeller, as shown in FIG. 11. Under the same air volume and efficiency conditions, the speed required by the non-equal diameter impeller is significantly lower than that required by the equal diameter impeller. Therefore, the fan using a non-equal diameter impeller can effectively increase the load and significantly reduce the speed while ensuring efficiency and air volume. Specific speed comparisons can be found in the table below.

Rotation speed/rpm

| No | Equal diameter solution | Non-equal diameter solution |
|---|---|---|
| 1 | 1850 | 1550 |
| 2 | 1500 | 1300 |
| 3 | 1300 | 1100 |

In some embodiments, in the air intake direction, the trailing edge 134 of the blade 13 extends obliquely away from the rotation direction of the impeller 10. That is, the trailing edge 134 of the blade 13 extends obliquely in the air intake direction, and in the rotation direction of the impeller 10, the end of the trailing edge 134 near the second end plate 12 is located upstream of the end of the trailing edge 134 near the first end plate 11. In this way, the flow field at the tail end of the outlet channel can be improved, so that the flow field has a phase difference in the intake direction, thereby improving aerodynamic noise. In some embodiments, the second reference plane is defined to pass through both the axis of the impeller 10 and the center point of the trailing edge 134 of the blade 13. The angle α between the trailing edge 134 of the blade 13 and the second reference plane is configured to α≤45°, that is, 0<α≤45°. In other embodiments, the trailing edge 134 of the blade 13 may extend obliquely toward the rotation direction of the impeller 10 in the intake direction, or the trailing edge 134 of the blade 13 may extend along the axis of the impeller 10.

It is worth mentioning that, through the design of the structural parameters such as shape and size of the above structure, the performance of the impeller of the present application is significantly improved compared with the traditional constant diameter impeller. When used in a fan, the efficiency of the fan using the non-equal diameter impeller of the present solution is significantly improved compared with the efficiency of the fan using the traditional solution. For a specific efficiency comparison, please refer to FIG. 12 and the table below.

Fan efficiency/%

| No | Traditional solution | The present solution |
|---|---|---|
| 1 | 18.81 | 20.98 |
| 2 | 19.81 | 29.9 |
| 3 | 20.4 | 33.1 |

The above are only some embodiments of the present application, and do not limit the scope of the present application thereto. Under the concept of the present application, equivalent structural transformations made according to the description and drawings of the present application, or direct/indirect application in other related technical fields are included in the scope of the present application.

1. An impeller, comprising:
a first end plate and a second end plate, the second end plate and the first end plate being sequentially spaced apart along an air intake direction of the impeller, the second end plate being provided with an air inlet; and
a plurality of blades spaced apart along a circumference of the impeller, the plurality of blades connecting the first end plate and the second end plate, the first end plate comprising a first plate portion and a second plate portion surrounding a periphery of the first plate portion, the second plate portion extending obliquely in the air intake direction away from an axis of the impeller.

2. The impeller according to claim 1, wherein the second end plate comprises a third plate portion and a fourth plate portion surrounding a periphery of the third plate portion, the fourth plate portion extending obliquely in the air intake direction away from the axis of the impeller.

3. The impeller according to claim 2, wherein a first reference plane is defined to be perpendicular to the axis of the impeller, and an angle γ between the second plate portion and the first reference plane is configured to be 10°≤γ≤40°, and/or an angle δ between the fourth plate portion and the first reference plane is configured to be 10°≤δ≤40°.

4. The impeller according to claim 2, wherein an outer diameter of the first end plate is smaller than an outer diameter of the second end plate.

5. The impeller according to claim 4, wherein:
a ratio of the outer diameter of the first end plate to the outer diameter of the second end plate is greater than or equal to 0.7; and/or
in a radial direction of the air inlet, a dimension between a projection line of a blade in the plurality of blades on an axial section of the air inlet and an axis of the air inlet gradually decreases along the air intake direction.

6. The impeller according to claim 4, wherein a blade in the plurality of blades has a first end and a second end that are sequentially distributed in the air intake direction, the second end extending outward in a radial direction of the impeller and beyond a periphery of the first end plate.

7. The impeller according to claim 6, wherein a trailing edge of the second end extends beyond the first end plate in the air intake direction; or a trailing edge of the second end has an outwardly convex transition fillet connected to an edge of the first end plate.

8. The impeller according to claim 1, wherein in the air intake direction, a trailing edge of a blade in the plurality of blades extends obliquely away from a rotation direction of the impeller.

9. The impeller according to claim 8, wherein a second reference plane is defined passing through both the axis of the impeller and a center point of the trailing edge of the blade, and an angle between the trailing edge of a blade in the plurality of blades and the second reference plane is less than or equal to 45°.

10. The impeller according to claim 1, wherein:
a blade in the plurality of blades has a first end and a second end sequentially distributed in the air intake direction, and a periphery of the second end plate extends radially outward from the impeller and beyond the first end; and/or
an outlet installation angle of the blade in the plurality of blades is less than 90°; and/or
a surface of the first plate portion is orthogonal to the axis of the impeller.

11. A fan, comprising: a motor and the impeller according to claim 1, a rotation shaft of the motor being provided on the first end plate of the impeller.

12. The fan according to claim 11, further comprising: an air deflector disposed upstream of the impeller and having a cross-sectional area that gradually decreases in the air intake direction, the air deflector having a drainage end and a guide end sequentially distributed in the air intake direction, the guide end extending into the air inlet of the second end plate.

13. The fan according to claim 12, wherein in a radial direction of the impeller, a gap d between the guide end and an edge of the air inlet is configured to be 4 mm≤d≤10 mm; and/or
a depth H of the guide end extending into the air inlet is configured to be 5 mm≤H≤15 mm.

14. An air handler, comprising: the impeller according to claim 1.

15. An air handler, comprising the fan according to claim 11.
